(19) United States
(12) Patent Application Publication
(10) Pub. No.: US 2022/0300985 A1
(43) Pub. Date: Sep. 22, 2022

(54) SYSTEM AND METHOD FOR REPAIR OF BROKEN DEVICES

(71) Applicant: Chamberlain C. St. Jean, Phoenix, AZ (US)

(72) Inventor: Chamberlain C. St. Jean, Phoenix, AZ (US)

(21) Appl. No.: 17/696,677

(22) Filed: Mar. 16, 2022

Related U.S. Application Data
(60) Provisional application No. 63/162,452, filed on Mar. 17, 2021.

(51) Int. Cl. G06Q 30/00; G06Q 30/02

(52) U.S. Cl. CPC G06Q 30/016; G06Q 30/0282; G06Q 30/012

(57) ABSTRACT

A system and method for repair of broken devices is disclosed. The system and method include a computer program and at least one server to host the computer program. The computer program may be provided as a software application and/or a website. The system and method allow any individual with a broken device (including, but not limited to, laptop computers, smartphones, tablet computers, and desktop computers) to easily find a vendor to repair the broken device. The system and method help streamline a repair service for vendors and works as a lead generator for service requests.

### CROSS-REFERENCE TO RELATED APPLICATION

The present application is related to and claims priority to U.S. Provisional Patent Application No. 63/162,452 filed Mar. 17, 2021, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of systems and methods for connecting consumers with providers of existing art and more specifically relates to a system and method for connecting device repair seekers with device repair providers.

### RELATED ART

The use of electronic devices rose exponentially in the 21st century and with technology improvements showing no signs of slowing down, it seems that ownership of electronic devices will continue to rise. Due to this widespread use of electronic devices, they are highly susceptible to damage caused by dropping and general every-day use. Further, although technology is always improving, it can be unpredictable and sometimes prone to causing software issues for the electronic device, such as boot loops, glitches, and the like.

As such, device repair companies have been established to perform hardware and software repairs on an individual's device. However, the repair process is often laborious as it can be difficult to find a trusted repair shop and the individual is often left without their device for long periods of time or without knowing a repair timeline for the device. Further, the individual must drop off and pick up their device from the repair shop, eating into time that they may not have.

### SUMMARY OF THE INVENTION

In view of the foregoing disadvantages inherent in the known systems and methods for connecting consumers with providers art, the present disclosure provides a novel system and method for repair of broken devices. The general purpose of the present disclosure, which will be described subsequently in greater detail, is to provide a means of connecting device repair seekers with device repair providers.

A system for facilitating repair of broken devices is disclosed herein. The system may include a computer program and at least one server. The computer program may include at least one set of computer executable commands, an authentication module, and an internet accessible interface. The at least one server may be configured to host the computer program. The at least one server may include at least one database and at least one processor; and the at least one server and the at least one processor may work in combination to serve the computer program. The at least one set of computer executable commands of the computer program may enable the computer program to receive at least one request from at least one user. The system may enable the at least one user having at least one broken device to immediately submit the at least one request for repair service to a group of vendors.

According to another embodiment, a method of using a system for facilitating repair of broken devices, is also disclosed herein. The method may include accessing a computer program, the computer program having at least one set of computer executable commands, an authentication module, and an internet accessible interface; viewing, on the computer program, a plurality of vendors; filtering the plurality of vendors based on at least one condition such that a group of vendors are displayed; selecting a selected vendor from the group of vendors; inputting, into the computer program, logistic option selections; inputting, into the computer program, broken device information relating to at least one broken device; inputting, into the computer program, payment information; sending the at least one broken device to the selected vendor; selectively tracking, via the computer program, repair progress of the at least one broken device; receiving at least one repaired electronic device from the selected vendor; and inputting, into the computer program, user input device information relating to the at least one repaired electronic device.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a system and method for repair of broken electronic devices, constructed and operative according to the teachings of the present disclosure.

FIG. 1 is a perspective view of a user with a broken electronic device, according to an embodiment of the disclosure.

FIG. 2 is a schematic diagram of a system for facilitating repair of broken electronic devices, according to an embodiment of the present disclosure.

FIG. 3 is a schematic diagram of the system for facilitating repair of broken electronic devices, according to an embodiment of the present disclosure.

FIG. 4 is a front view of a computer program on an electronic device and illustrating a map view of a group of vendors, according to an embodiment of the present disclosure.

FIG. 5 is a front view of the computer program on the electronic device and illustrating a payment gateway, according to an embodiment of the present disclosure.

FIG. 6 is a flow diagram illustrating a method of facilitating repair of broken electronic devices, according to an embodiment of the present disclosure.

FIG. 7 is a flow diagram illustrating a method of using a system for facilitating repair of broken electronic devices according to an embodiment of the present disclosure.

FIG. 8 is a flow diagram illustrating a method of using a system for facilitating repair of broken electronic devices according to another embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to systems and methods for connecting consumers with providers and more particularly to a system and method for repair of broken devices as used to improve the repair process for broken devices. Generally, the systems and methods may include website and mobile application services both for vendors and users. Users may be any individual with a broken mobile device which includes laptops, phones, tablets, computers, desktops, and any electronic devices on the platform that needs to be repaired. The system and method may help streamline a repair service for vendors and works as a lead generator for service requests.

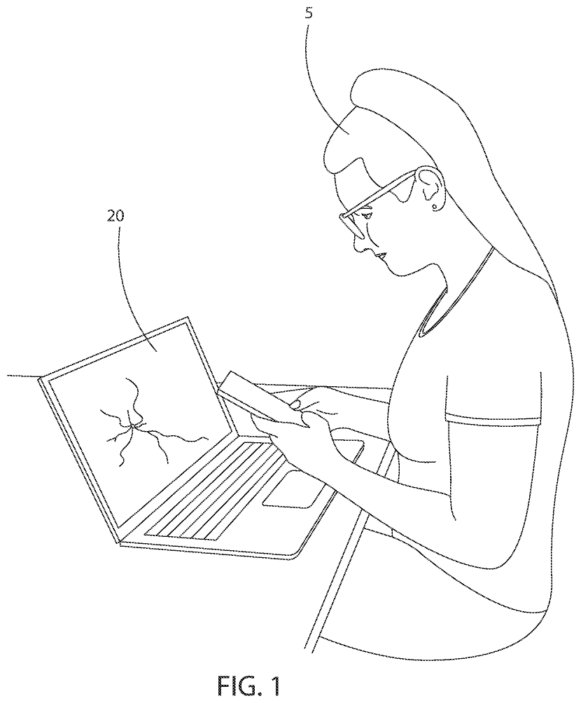

Referring now more specifically to the drawings by numerals of reference, there is shown in FIGS. 1-8, various views of a system 100 and methods, 200, 300, 400.

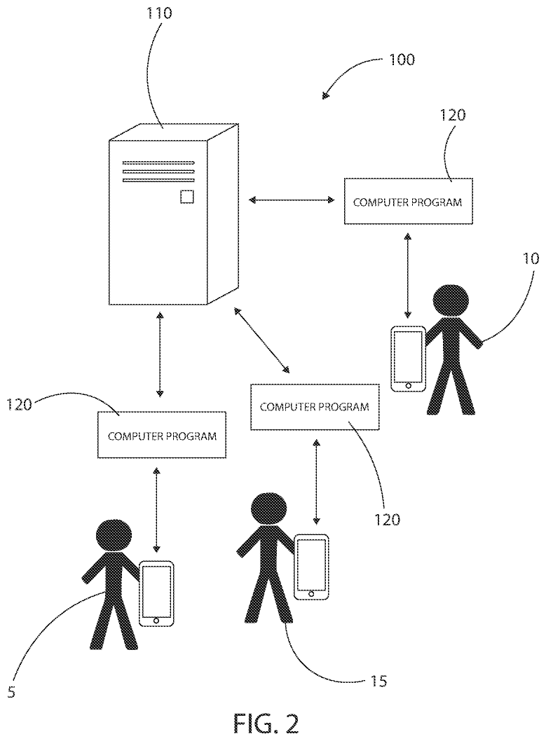

As shown and as discussed above, the system 100 may be used for facilitating repair of broken devices 20. In some embodiments as shown in FIGS. 2-5, the system 100 may include a computer program 120 and at least one server 110. The computer program 120 may include at least one set of computer executable commands, an authentication module and an internet accessible interface. The computer program 120 may be accessible via an electronic device. For example, the computer program 120 may be a software application downloadable to the electronic device. The at least one server 110 may be configured to host the computer program 120.

The at least one set of computer executable commands may enable the computer program 120 to receive at least one request from at least one user 5 and the system 100 as a whole may enable the at least one user 5 having at least one broken device 20 to immediately submit said at least one request for repair service to a group of vendors 10. In some embodiments, the system 100 may further facilitate pickup and delivery, via a plurality of drivers 15, of the at least one broken device 20. In addition, the system 100 may facilitate pickup and delivery, via the plurality of drivers 15, of the at least one repaired electronic device.

The authentication module may provide users 5, vendors 10 and drivers 15 the ability to access the computer program 120 upon verification. For example, the authentication module may store passwords and/or unique codes relating to the users 5, vendors 10 and drivers 15. In some embodiments, the authentication module may prompt the users 5, vendors 10 and drivers 15 to enter their phone number, send a text message with a unique code to the phone number for text verification, and authenticate (or deny) the unique code input from the users 5, vendors 10 and drivers 15. Once verified, the internet accessible interface may enable the users 5, vendors 10 and drivers 15 to utilize the computer program 120 and communicate with the at least one server 110 via the computer program 120.

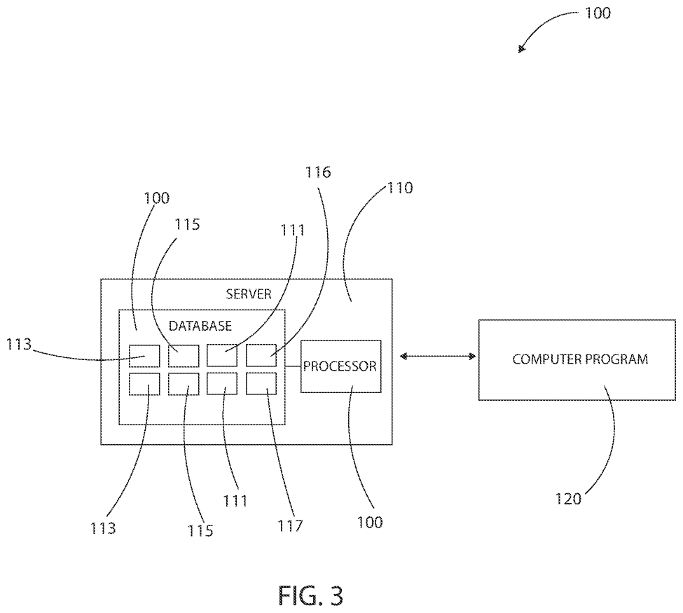

As shown in FIG. 3, the at least one server 110 may include at least one database 112 and at least one processor 114. The at least one server 110 and the at least one processor 114 may work in combination to serve the computer program 120. The at least one database 112 may be configured to store a plurality of vendor profiles 111 each corresponding to each one of a plurality of vendors 10 (FIG. 2). Each of the plurality of vendor profiles 111 may include vendor information relating to the each one of the plurality of vendors 10. For example, the vendor information may include (but is not limited to) name (first and last name), email address, phone number, vendor shop name, primary contact for vendor shop, employee identification number, secondary contact, certifications, questions, information about the vendor shop, username, password, years in service, reviews, etc.

Further, the at least one database 112 may be configured to store a plurality of user profiles 113, each corresponding to each one of a plurality of users 5 (FIG. 2). Each one of the plurality of user profiles 113 may include user information relating to each one of the plurality of users 5. For example, the user information may include (but is not limited to) username, password, email, phone number, International Mobile Equipment Identity (“IMEI”) number of at least one broken device 20. In addition, the at least one database 112 may be configured to store a plurality of driver profiles 115 each corresponding to each one of a plurality of drivers 15. Each of the plurality of driver profiles 115 may include driver 15 information relating to each one of the plurality of drivers 15. For example, the driver information may include (but again is not limited to) username, password, email address, driver license information such as driving license number and photo ID, mailing address, billing address, etc.

Upon initial use of the computer program 120, the user 5, vendor 10 and drivers 15 may access the computer program 120 as discussed above and may register an account. In the case of a vendor 10 (providing repair services), the vendor 10 may access the computer program 120 by either downloading the software application or accessing a website; and registering a vendor 10 account by providing the vendor information. The vendor 10 may also provide their availability each day. For example, the computer program 120 may enable the vendor 10 to “switch on” availability to take repair requests.

In the case of a user 5 (seeking repair services), the user 5 may download the software application; receive a prompt to deny or grant access for the software application to access information on the user's device; and register an account by providing the user information. Particularly, the user 5 may provide username, password, email address and phone number. Further, in some embodiments, the drivers 15 may be third party driver 15 providing services. In other embodiments, the drivers 15 may sign up directly through the system 100. For drivers 15 signing up directly through the system 100, the driver 15 may download the software application; and register an account by providing the driver information. For third party drivers 15, middleware may be provided that connects third party driver service provider systems (such as other applications) with the computer program 120.

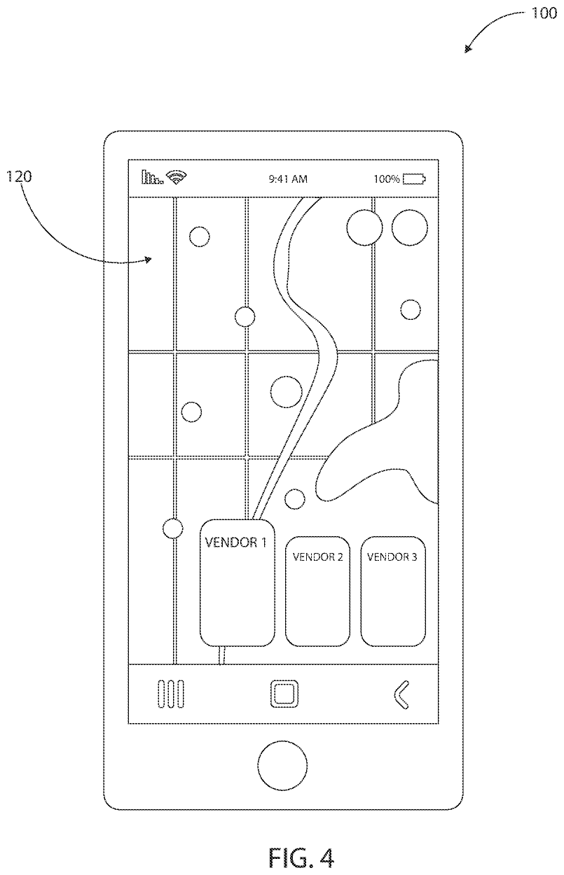

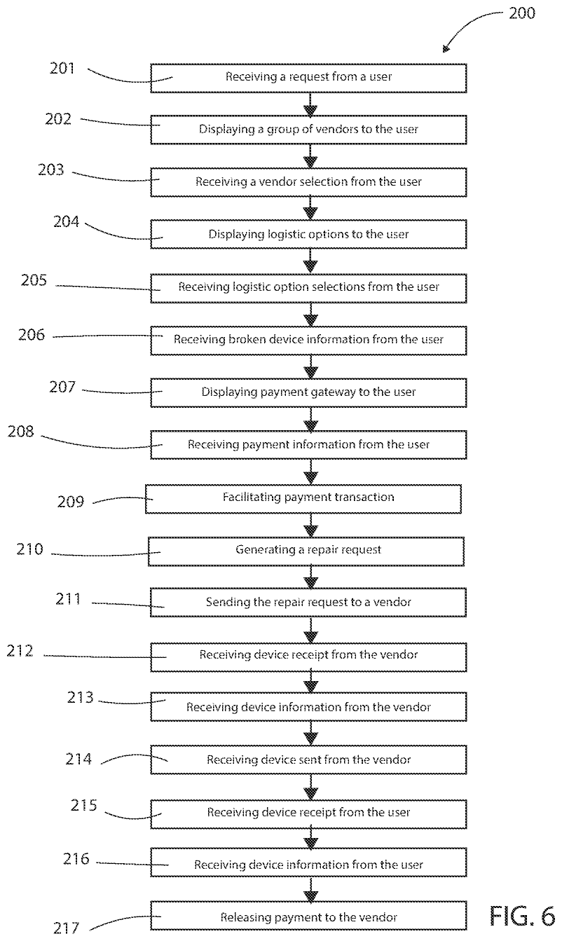

As shown in FIG. 6, a method 200 may be provided for facilitating repair of at least one broken device 20. For example, as shown above, the at least one set of computer executable commands of the computer program 120 may enable the computer program 120 to perform a step 201 of receiving at least one request from at least one user 5. Further, the at least one set of computer executable commands of the computer program 120 may enable the computer program 120 to perform a step 202 of displaying the group of vendors 10 to the at least one user 5. Preferably, the group of vendors 10 may be displayed on a map (as shown in FIG. 4). Further, preferably, the group of vendors 10 may be chosen from the plurality of vendors 10 by the system 100 based on at least one condition. For example, the at least one condition may include at least one of a proximity of each of the plurality of vendors 10, an availability of each of the plurality of vendors 10, a pricing of each of the plurality of vendors 10 and/or a rating of each of the plurality of vendors 10.

As such, when the at least one user 5 makes the request, they may include information in the request to allow the computer program 120 to generate the group of vendors 10 that is specific to the request. For example, the user 5 may input their location, or desired repair location; information pertaining to the broken device 20 (such as whether a laptop, smartphone, desktop computer, etc.); when they require the repair of the device, etc. This may be achieved via a ‘filter’ feature displayed on the computer program 120 to the at least one user 5.

The computer program 120 may further be configured to perform a step 203 of receiving a vendor selection from the at least one user 5. Prior to this step, as shown in FIG. 4, the computer program 120 may enable the at least one user 5 to view vendor profiles 111 for each of the group of vendors 10 to enable the at least one user 5 to view ratings, reviews, location, etc. to make the decision as to which vendor 10 they wish to use for the repair service. The computer program 120 may then be configured to display logistic options for the repair service of the at least one broken device 20. For example, the logistic options may include options such as, but not limited to, pick-up information such as date, whether driver 15 is requested or whether mail drop-off is requested etc.; drop-off information, again such as date and whether driver 15 or mail is requested; time frame; and/or mailing address or alternative address.

In addition to this, the computer program 120 may be configured to perform a step 204 of receiving broken device information from the at least one user 5. For example, the at least one user 5 may input information such as (but not limited to) the type of device (for example, whether smartphone, laptop, desktop computer, etc.) and type of damage to the device (for example, whether cracked screen, software malfunction, water damage, etc.)

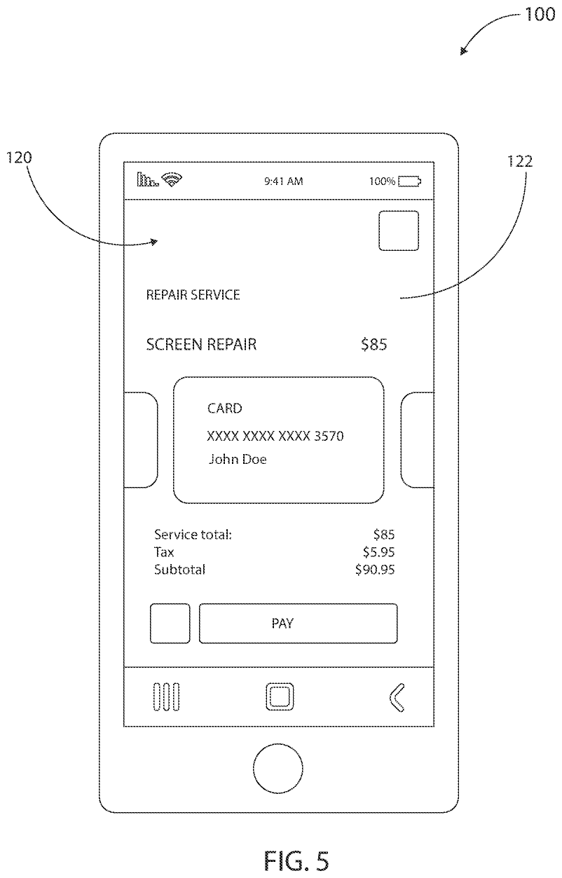

In some embodiments, as shown in FIG. 6, the computer program 120 may further be configured to perform a step of 205 facilitating payment from the at least one user 5 for the repair service. As such, the computer program 120 may include a payment gateway 122, as shown in FIG. 5. The computer program 120 may be configured to perform a step 206 of displaying the payment gateway 122 to the at least one user 5; step 207, receiving payment information from the at least one user 5 (such as credit or debit card information, third party merchant information, bank account information, etc.) and step 208, facilitating a payment transaction for the repair service. Preferably, the computer program 120 may withhold payment from vendors 10 until the repair service has been completed.

Once payment has been accepted, the computer program 120 may be configured to perform a step 209 of generating a repair request and send the repair request to a selected vendor 10. For example, the selected vendor 10 may receive a notification to alert them as to the repair request. The selected vendor 10 may then either deny or accept the repair request. If the selected vendor 10 denies the repair request, the repair request may go back into a queue for another vendor 10 to select. Preferably, the queue may be viewable by vendors 10 with similar conditions as the previous vendor 10 (for example, location, availability, reviews, ratings, etc.) In some embodiments, the computer program 120 may be configured to store denied requests in the at least one database 112.

If the selected vendor 10 accepts the request, the repair service may then be assigned to them and recorded on the at least one database 112. At this stage, the at least one user 5 may then send the at least one broken device 20 to the selected vendor 10. As above, this may be achieved by either the at least one user 5 mailing the at least one broken device 20, or one of the plurality of drivers 15 picking up and delivering the at least one broken device 20. As such, the computer program 120 may perform a step 210 of sending a request to a group of drivers 15 from the plurality of drivers 15. The group of drivers 15 may be automatically selected by the computer program 120 based on availability, location, etc. or may be sent automatically to a third party driver 15 provider automatically who may provide the driver 15.

If pick up by driver 15 is selected, in some embodiments, the driver 15 may input device information and as such, the computer program 120 may be configured to perform a step of 211, receiving the driver input device information. Again, this may be directly via the computer program 120 or via middleware connecting the third party driver provider to the computer program 120. Preferably, the driver input device information may include one or more photos of the at least one broken device 20.

The computer program 120 may then be configured to perform a step 212 of receiving vendor 10 input device information from the selected vendor 10. Particularly, once the selected vendor 10 has received the at least one broken device 20 they may then input the vendor input device information. Preferably, the vendor input device information may include one or more photos of the at least one broken device 20. The selected vendor 10 may then begin the repair service. During this process, preferably, the computer program 120 may enable repair process tracking for the at least one user 5. As such, the at least one user 5 may, via the computer program 120, selectively track the repair process.

Once the repair service is completed, the selected vendor 10 may input second vendor input device information. Preferably, the second vendor input device information may include one or more photos of at least one repaired device. The selected vendor 10 may then, via the computer program 120, notify of the sending of the at least one repaired device. Again, this may be achieved via mailing, or via a third party driver 15. As such, the computer program 120 may be configured to perform a step 213 of receiving a device sent input from the selected vendor 10.

Once received, the at least one user 5 may then, via the computer program 120, notify of the receipt of the at least one repaired device. As such, the computer program 120 may be configured to then perform a step 214 of receiving a second device receipt input from the at least one user 5 and a step 215 of to receiving user 5 input device information from the at least one user 5. For example, preferably, the at least one user 5 may perform a final inspection and the user 5 input device information may include one or more photos of the at least one repaired device, diagnostic information for the at least one repaired device, acceptance of the at least one repaired device, etc.

As such, in some embodiments, the computer program 120 may be configured to, upon request, perform at least one diagnostic test of the at least one repaired electronic device. For example, once the computer program 120 receives the second device receipt input from the at least one user 5, the computer program 120 may prompt the at least one user 5 to perform at least one diagnostic test via the computer program 120, to ensure that the at least one repaired device is, in fact, repaired. For example, the at least one diagnostic test may include, but not limited to, an LCD test, digitizer test, battery test, speaker(s) test, mic test, camera(s) test, network connectivity test, volume control test, DND slider test, charging port test, headphone jack test, and/or home button test.

In some embodiments, the at least one user 5 may run at least one diagnostic test on the at least one repaired device at any stage after repair. Upon acceptance of the at least one repaired device, the computer program 120 may be configured to perform a step 316 of releasing payment to the selected vendor 10. Further, in some embodiments, at this stage the at least one user 5 may be prompted, via the computer program 120, to leave a review for the selected vendor 10. The review may be stored on the vendor 10 profile for the selected vendor 10 for other users 5 to view.

In some embodiments, the at least one database 112 may be configured to store help information 116 and service information 117, and upon request by the user 5, the computer program 120 may be configured to display the help information 116 and service information 117, respectively. The service information 117 may include information including, but not limited to, past repair service information 117, active repair service information 117, reward points, insurance coverage information, warranty information (for example from the vendor 10 and/or from the system 100), upgrade information, purchase plan information, protection plan information, etc.

The help information 116 may include information such as diagnostic test information and reports. In some embodiments, the computer program 120 may further be configured to, upon request, perform at least one diagnostic test of the at least one broken device 20. Particularly, the at least one user 5 may, via the computer program 120, run diagnostic tests on their at least one broken device 20—this may enable the at least one user 5, the computer program 120 and/or the selected vendor 10 to assess damage to the at least one broken device 20 (as long as the at least one broken device 20 is able to be powered on, the screen is viewable, etc.)

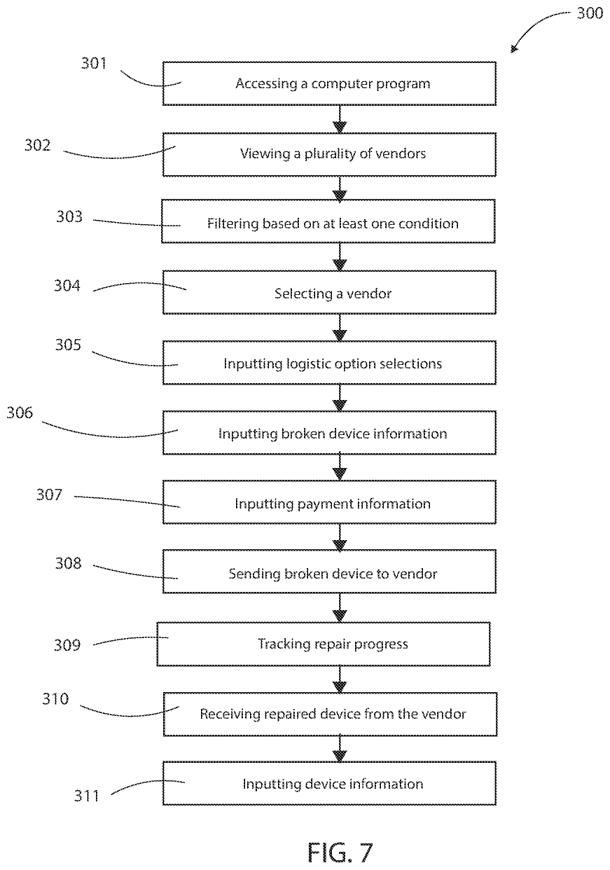

Referring now specifically to FIG. 7, there is shown a method 300 of using a system for facilitating repair of broken devices 20. This method may represent how the at least one user 5 may utilize the system 100. As shown, the method 300 may comprise the steps of: step 301, accessing a computer program 120 (for example the software application), the computer program 120 having at least one set of computer executable commands, an authentication module, and an internet accessible interface; step 302, viewing, on the computer program 120, a plurality of vendors 10; step 303, filtering the plurality of vendors 10 based on at least one condition such that a group of vendors 10 are displayed; step 304, selecting a selected vendor 10 from the group of vendors 10; step 305, inputting, into the computer program 120, logistic option selections; step 306, inputting, into the computer program 120, broken device 20 information relating to at least one broken device 20; step 307, inputting, into the computer program 120, payment information; step 308, sending the at least one broken device 20 to the selected vendor 10; step 309, selectively tracking, via the computer program 120, repair progress of the at least one broken device 20; step 310, receiving at least one repaired electronic device from the selected vendor 10; and step 311, inputting, into the computer program 120, user 5 input device information relating to the at least one repaired electronic device.

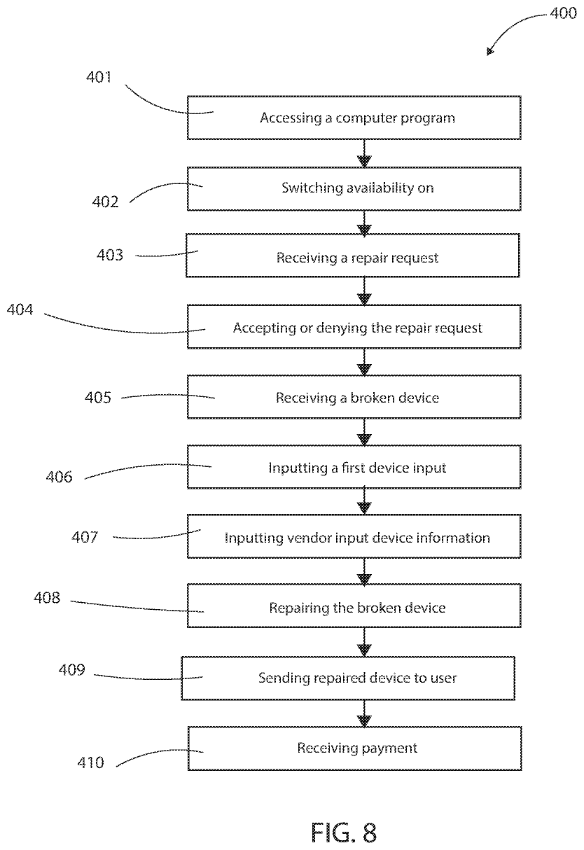

Referring now specifically to FIG. 8, a method 400 of using a system for facilitating repair of broken devices 20. This method may represent how each vendor 10 may utilize the system 100. As shown, the method may comprise the steps of: step 401, accessing a computer program 120 (whether a website or software application), the computer program 120 having at least one set of computer executable commands, an authentication module, and an internet accessible interface; step 402, selectively switching on, via the computer program 120, availability to receive repair requests; step 403, receiving, via the computer program 120, at least one repair request from at least one user 5, the at least one repair request including information pertaining to at least one broken device 20; step 404, one of accepting and denying, via the computer program 120, the at least one repair request; step 405, upon acceptance of the at least one repair request receiving the at least one broken device 20 (via either a driver 15 or via mail); step 406, inputting, via the computer program 120, a first device receipt input; step 407, inputting, via the computer program 120, vendor input device information; step 408, repairing the at least one broken device 20; step 308, sending at least one repaired device to the at least one user 5; step 409, receiving payment via the computer program 120.

It should be noted that certain steps are optional and may not be implemented in all cases. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for facilitating repair of broken devices are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A system for facilitating repair of broken devices, the system comprising:
a computer program having at least one set of computer executable commands, an authentication module, and an internet accessible interface; and
at least one server configured to host said computer program, the at least one server having at least one database and at least one processor, the at least one server and the at least one processor working in combination to serve said computer program;
wherein said at least one set of computer executable commands of the computer program enable the computer program to receive at least one request from at least one user; and
wherein said system enables the at least one user having at least one broken device to immediately submit said at least one request for repair service to a group of vendors.

2. The system of claim 1, wherein the at least one database is configured to store a plurality of vendor profiles each corresponding to each one of a plurality of vendors, and wherein each the of the plurality of vendor profiles includes vendor information relating to said each one of the plurality of vendors.

3. The system of claim 2, wherein the group of vendors are selected from the plurality of vendors, by the system, based on at least one condition.

4. The system of claim 3, wherein the at least condition includes at least one of a proximity of said each of the plurality of vendors, an availability of said each of the plurality of vendors, a pricing of said each of the plurality of vendors and a rating of said each of the plurality of vendors.

5. The system of claim 2, wherein the at least one database is further configured to store a plurality of user profiles, each corresponding to each one of a plurality of users, and wherein each the of the plurality of user profiles includes user information relating to said each one of the plurality of users.

6. The system of claim 5, wherein the at least one database is configured to store a plurality of driver profiles each corresponding to each one of a plurality of drivers, and wherein each the of the plurality of driver profiles includes driver information relating to said each one of the plurality of drivers.

7. The system of claim 6, wherein the at least one database is further configured to store help information, and wherein the computer program is configured to, upon request by the user, display the help information to the user.

8. The system of claim 7, wherein the at least one database is further configured to store service information.

9. The system of claim 8, wherein the computer program is configured to, upon request, perform at least one diagnostic test of one of the at least one broken device and at least one repaired electronic device.

10. The system of claim 1, wherein the computer program further includes a payment gateway configured to facilitate payment from the at least one user for the repair service.

11. The system of claim 1, wherein the system further facilitates pickup and delivery, via the plurality of drivers, of the at least one broken device.

12. The system of claim 11, wherein the system further facilitates pickup and delivery, via the plurality of drivers, of the at least one repaired electronic device.

13. The system of claim 1, wherein computer program enables repair process tracking for the at least one user.

14. The system of claim 1, wherein said at least one set of computer executable commands of the computer program enable the computer program to:
receive the at least one request from the at least one user;
display the group of vendors to the at least one user, the group of vendors selected based on information contained in the at least one request;
receive a vendor selection from the at least one user;
display logistic options for the repair service of the at least one broken device;
receive logistic option selections from the at least one user;
receive broken device information from the at least one user;
display the payment gateway to the at least one user;
receive payment information from the at least one user;
facilitate a payment transaction for the repair service;
generate a repair request;
send the repair request to a selected vendor;
receive a first device receipt input from the selected vendor;
facilitate repair process tracking for the at least one user;
receive vendor input device information from the selected vendor;
receive a device sent input from the selected vendor;
receive a second device receipt input from the at least one user;
receive user input device information from the at least one user; and
release payment to the selected vendor.

15. A system for facilitating repair of broken devices, the system comprising:
a computer program having at least one set of computer executable commands, an authentication module, and an internet accessible interface; and
at least one server configured to host said computer program, the at least one server having at least one at least one database and at least one processor, the at least one server and the at least one processor working in combination to serve said computer program, the at least one database configured to store a plurality of vendor profiles each corresponding to each one of a plurality of vendors, a plurality of user profiles each corresponding to each one of a plurality of users, and a plurality of driver profiles each corresponding to each one of a plurality of driver, each the of the plurality of vendor profiles includes vendor information relating to said each one of the plurality of vendors, wherein each the of the plurality of user profiles includes user information relating to said each one of the plurality of users and each the of the plurality of driver profiles includes driver information relating to said each one of the plurality of driver;
wherein said at least one set of computer executable commands of the computer program are enable the computer program to:
receive the at least one request from the at least one user;
display the group of vendors to the at least one user, the group of vendors selected based on information contained in the at least one request;
receive a vendor selection from the at least one user;
display logistic options for the repair service of the at least one broken device;
receive logistic option selections from the at least one user;
receive broken device information from the at least one user;
display the payment gateway to the at least one user;
receive payment information from the at least one user;
facilitate a payment transaction for the repair service;
generate a repair request;
send the repair request to a selected vendor;
receive a first device receipt input from the selected vendor;
facilitate repair process tracking for the at least one user;
receive vendor input device information from the selected vendor;
receive a device sent input from the selected vendor;
receive a second device receipt input from the at least one user;
receive user input device information from the at least one user; and
release payment to the selected vendor;
wherein the computer program further includes a payment gateway configured to facilitate payment from the at least one user for the repair service;
wherein the system further facilitates pickup and delivery, via the plurality of drivers, of the at least one broken device;
wherein the system further facilitates pickup and delivery, via the plurality of drivers, of the at least one repaired electronic device; and
wherein the group of vendors are selected from the plurality of vendors, by the system, based on at least one condition, and wherein the at least condition includes at least one of proximity of said each of the plurality of vendors, availability of said each of the plurality of vendors, pricing of said each of the plurality of vendors and rating of said each of the plurality of vendors.

16. The system of claim 15, wherein the at least one database is configured to store help information, and wherein the computer program is configured to, upon request by the user, display the help information to the user.

17. The system of claim 16, wherein the at least one database is further configured to store service information.

18. The system of claim 15, wherein the computer program is configured to, upon request, perform at least one diagnostic test of one of the at least one broken device and at least one repaired electronic device.

19. The system of claim 15, wherein computer program enables repair process tracking for the at least one user.

20. A method of using a system for facilitating repair of broken devices, the method comprising the steps of:
accessing a computer program, the computer program having at least one set of computer executable commands, an authentication module, and an internet accessible interface;
viewing, on the computer program, a plurality of vendors;
filtering the plurality of vendors based on at least one condition such that a group of vendors are displayed;
selecting a selected vendor from the group of vendors;
inputting, into the computer program, logistic option selections;
inputting, into the computer program, broken device information relating to at least one broken device; and
inputting, into the computer program, payment information;
sending the at least one broken device to the selected vendor;
selectively tracking, via the computer program, repair progress of the at least one broken device;
receiving at least one repaired electronic device from the selected vendor; and
inputting, into the computer program, user input device information relating to the at least one repaired electronic device.
